(19) United States
(12) Patent Application Publication
(10) Pub. No.: US 2007/0046495 A1
(43) Pub. Date: Mar. 1, 2007

(54) Electronic apparatus, electronic apparatus system and remote control method for electronic apparatus

(75) Inventor: Hiroki Kumagai, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/494,461

(22) Filed: Jul. 28, 2006

(30) Foreign Application Priority Data
Aug. 25, 2005 (JP) 2005-244535

(51) Int. Cl. G08C 19/00

(52) U.S. Cl. 340/825.72; 340/825.69; 340/3.42; 340/825.22; 340/825.52

(57) ABSTRACT

According to one embodiment, an electronic apparatus which is installed in an environment in which the apparatus receives a remote control signal from the same remote controller in common with other electronic apparatuses, including a receiving unit configured to receive the remote control signal, a determination unit configured to determine one electronic apparatus to receive the remote control signal among at least one or more electronic apparatuses including the electronic apparatus able to receive the remote control signal, and a setting unit configured to operate to accept the remote control signal received by the receiving unit when a determination result resulting from the determination unit shows the electronic apparatus as the one to receive the remote control, and to operate so as to disregard the remote control signal received by the receiving unit when the result shows electronic apparatuses other than the electronic apparatus.

### CROSS-REFERENCE TO RELATED APPLICATIONS

This application is based upon and claims the benefit of priority from Japanese Patent Application No. 2005-244535, filed Aug. 25, 2005, the entire contents of which are incorporated herein by reference.

### BACKGROUND

1. Field

One embodiment of the invention relates to a remote control technique for an electronic apparatus, which is capable of performing a remote operation by a remote controller.

2. Description of the Related Art

In recent years, many home electronic apparatuses have become able to perform remote operations by remote controllers. In particular, in such type of electronic apparatuses called audio visual (AV) apparatuses, it is not unusual that the same type of electronic apparatuses are usually set as a plural, so that a variety of measures so as not to cause malfunctions caused by a remote operation from a remote controller have been presented (for example, Jpn. Pat. Appln. KOKAI Publication No. 2005-33651).

The method disclosed in Jpn. Pat. Appln. KOKAI Publication No. 2005-33651 is one which has a scheme to set reception propriety of a remote control signal from the remote controller on each main body apparatus side, and can limit a remote operation object by the remote controller only to the apparatus A, for instance, by setting apparatuses B and C among apparatuses A-C to the states of reception inhibition of each remote control signal. In other words, the method can prevent the apparatus B and C from performing operations, which have not been intended by a user, by the operations through the remote controller operated for the apparatus A.

By the way, in the assumption that a user intends to switch a remote operation object by the remote controller from the apparatus A to the apparatus B, the method disclosed in the above-described patent document 2005-33651 inhibits the reception of the remote control signal for the apparatus A and resets for accepting the reception of the remote control signal for the apparatus B though the operation on the main body apparatus sides individually. The case to further switch the remote operation object from the apparatus B to the apparatus C and to return to the apparatus A go the same.

There is a method for enabling only a desired apparatus among a plurality of apparatuses from being remotely operated at different times by providing a switch for switching the remote operation objects on the remote controller side and operating the switch. However, this method places restrictions on the number such that the number of apparatuses possible to become the remote operation objects is limited by the number resulting from the number of states of the switch provided for the remote controller.

That is to say, the method can never appropriately perform remote operations of each apparatus by readily switching the operation objects of the remote controller among a plurality of apparatuses while sitting on a sofa or the like without having to put any restriction on the number of the apparatus that are the remote operation objects.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a use form of an electronic apparatus system regarding an embodiment of the present invention;

FIG. 2 is an exemplary view showing a display of a reception priority of a remote control signal on a liquid crystal display (LED) of a digital recorder of the embodiment;

FIG. 3 is an exemplary view showing a schematic configuration of the digital recorder of the embodiment;

FIG. 4 is an exemplary view showing management data stored in the digital recorder of the embodiment;

FIG. 5 is an exemplary flowchart showing an operation procedure when the digital recorder of the embodiment receives a remote control signal from a remote controller; and

FIG. 6 is an exemplary flowchart showing an operation procedure of update processing of a remote control signal receiving apparatus list, which is executed by the digital recorder of the embodiment.

### DETAILED DESCRIPTION

Various embodiments according to the invention will be described hereinafter with reference to the accompanying drawings. In general, according to one embodiment of the invention, an electronic apparatus which is installed in an environment in which the apparatus receives a remote control signal from the same remote controller in common with other electronic apparatuses, including a receiving unit configured to receive the remote control signal, a determination unit configured to determine one electronic apparatus to receive the remote control signal among at least one or more electronic apparatuses including the electronic apparatus able to receive the remote control signal, and a setting unit configured to operate to accept the remote control signal received by the receiving unit when a determination result resulting from the determination unit shows the electronic apparatus as the one to receive the remote control, and to operate so as to disregard the remote control signal received by the receiving unit when the result shows electronic apparatuses other than the electronic apparatus.

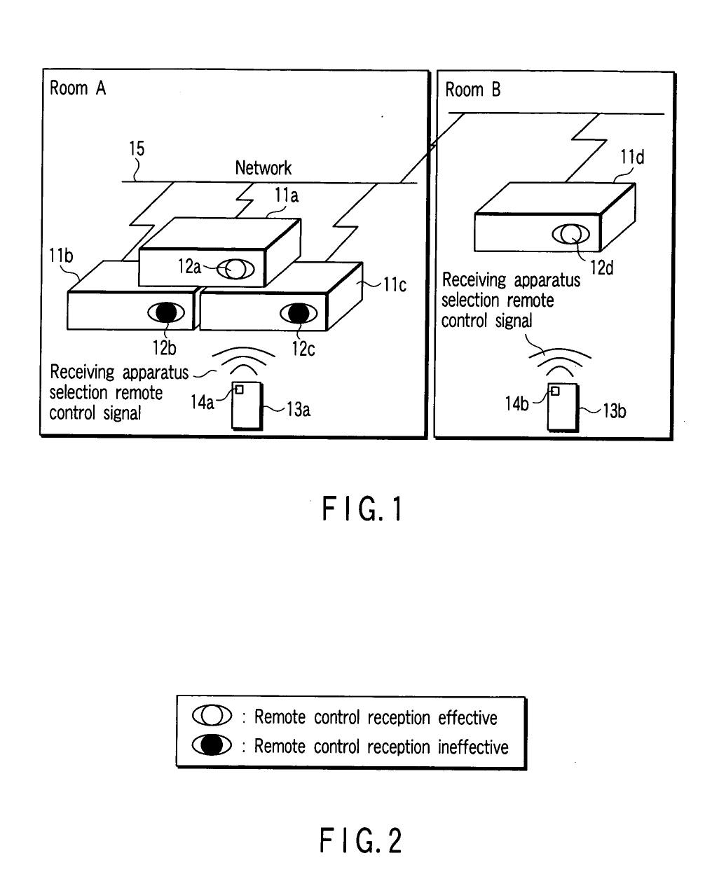

FIG. 1 is an exemplary view showing a use form of an electronic apparatus of the embodiment. Here, the embodiment realizes the electronic apparatus as a digital recorder.

It is presumed that a room A and a room B are two rooms different from each other in the same house, and the room A is provided with three digital recorders 11a-11c and the room B is provided with one digital recorder 11d. The four digital recorders 11a-11d receive identical remote control signals and have LEDs (12a-12d) indicating whether or not the digital recorders 11a-11d are each in states to receive the remote control signals.

The remote control signals cannot propagate from the room A to the room B or from the room B to the room A beyond the boundary between different rooms. Therefore, the room A and room B get remote controller 13a and 13b ready, respectively. And the remote controllers 13a and 13b are provided with switching buttons 14a and 14b to transmit below-mentioned receiving apparatus selection remote control signals, respectively.

The digital recorders 11a-11d are each connected to a network 15 using Ethernet (registered trademark) and configured to transmit/receive data with one another via the network 15.

Hereinafter, the digital recorders 11a-11b, the LEDs 12a-12d, the remote controllers 13a and 13b, and the switching buttons 14a and 14b are sometimes referred collectively to as digital recorder 11, the LED 12, the remote controller 13 and the switching button 14, respectively.

FIG. 2 is an exemplary view showing a display of a reception priority of a remote control signal on an LED 12 of each digital recorder 11, and here, it is provided that the state of an acceptance of a reception of the remote control signal is indicated with white and the state of a prohibition thereof is indicated with black. In the room A shown in FIG. 1, the LEDs 12a-12c indicate that the digital recorder 11a can receive the remote control signal from the remote controller 13a and the digital recorders 11b and 11c are in states of reception inhibition of the remote control signals therefrom.

The electronic apparatus system of the embodiment then enables the digital recorder capable of receiving the remote control signal switch, for instance, from the digital recorder 11a to the digital recorder 11b by the operation of the remote controller 13a, and hereinafter, this point of the forgoing operation will be described in detail.

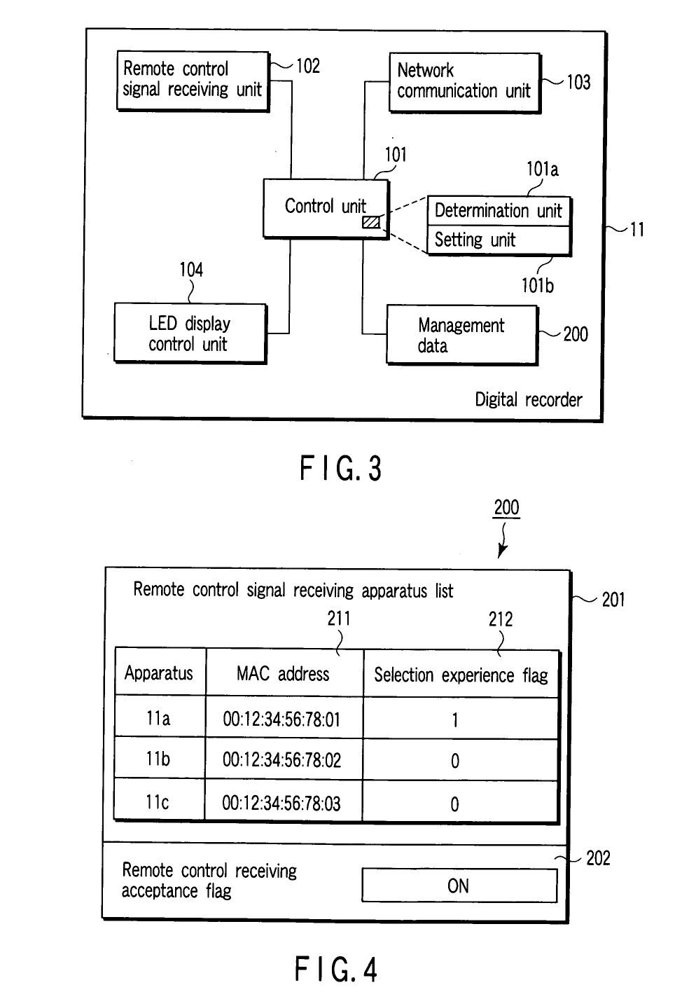

FIG. 3 is an exemplary view showing a schematic configuration of the digital recorder 11. As shown in FIG. 3, the digital recorder 11 includes each of processing units that are a control unit 101, a remote control signal receiving unit 102, a network communication unit 103 and an LED display control unit 104 and also has management data 200.

The control unit 101 controls operation control of the whole of the digital recorder 11 and as one sphere of the control, it includes a determination unit 101a determining an apparatus to receive the remote control signal among a plurality of apparatuses including its own apparatus and a setting unit 101b setting a reception priority of a remote control signal on the basis of the determination of the determination unit 101a.

The remote control signal receiving unit 102 receives the remote control signal from the remote controller 13. The network communication unit 103 executes transmission of data to the network 15 and acquisition of data therefrom. The LED display unit 104 executes drive control of the LED 12.

The management data 200 is data that is stored so as to realize remote control to switch the digital recorder receiving the remote control signal by the remote controller 13, and FIG. 4 shows an example of the structure of the management data 200.

The management data 200, as shown in FIG. 4, is composed of a remote control receiving signal apparatus list 201 and a remote control signal receiving acceptance flag 202.

The device list 201 is one that shows apparatuses forming a group in receiving the remote control signals and stores MAC addresses (211) of identification IDs of the apparatuses forming an identical group on the network 15. The management data 200 includes selection experience flags (212) storing whether or not that each apparatus has brought into a state of an acceptance of its remote control signal.

On the other hand, the flag 202 is one that indicating whether or not each apparatus is receivable of the remote control signal and the flag is cooperative with the state of the LED 12 of each apparatus.

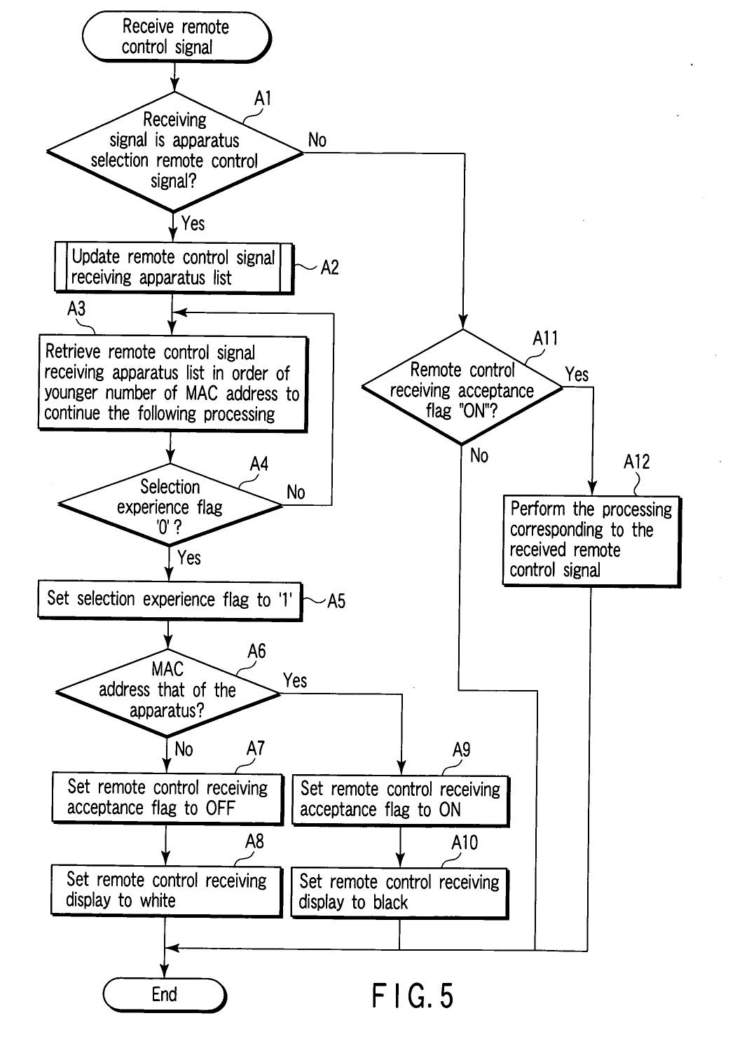

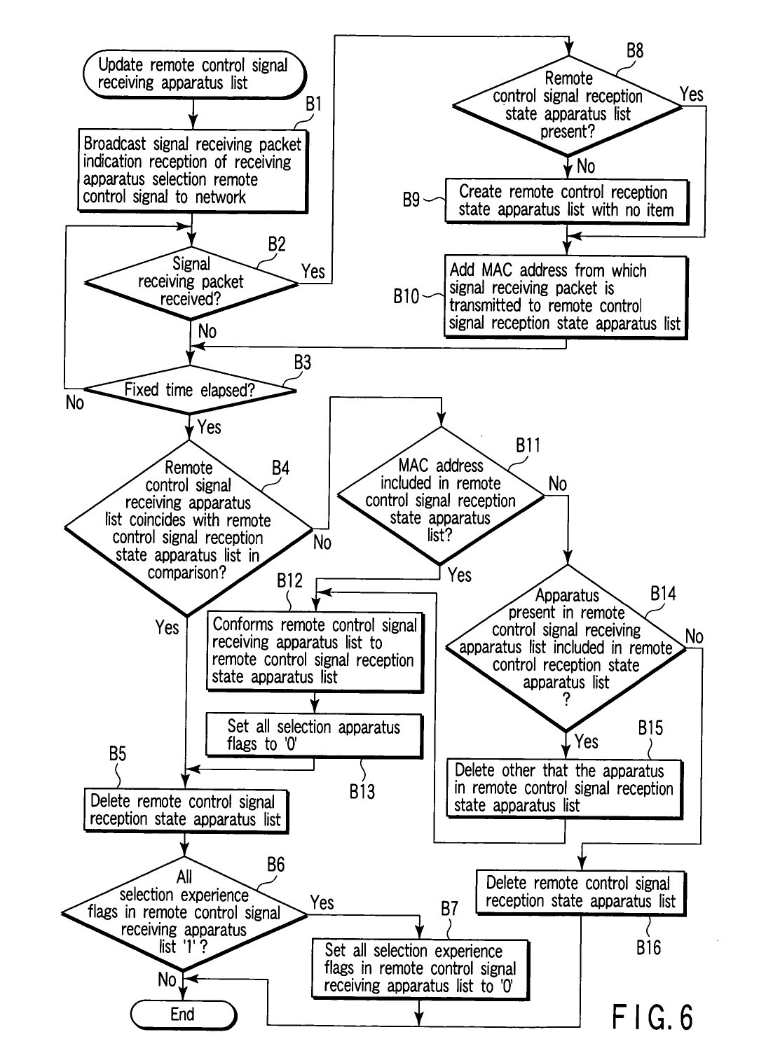

Next, the operation procedure in relation to the remote control of the digital recorder 101 of the embodiment having such configuration will be explained by referring to flowcharts in FIG. 5 and FIG. 6.

FIG. 5 is an exemplary flowchart showing an operation procedure when the digital recorder 101 receives the remote control signal from the remote controller 13.

When the receiving unit 102 receives the remote control signal, the control unit 101 determines whether or not the received signal is a receiving apparatus selection remote control signal (block A1). The selection remote control signal is a signal that is transmitted when the switching button provided for the remote controller 13 is pressed. If the received signal is a signal other than the selection remote control signal (No, in block A1), the control unit 101 determines whether the acceptance flag 202 is on or off (block A11), and if it is off (No, in block A11), the control unit 101 ends processing regardless of the received remote control signal. In contrast, if it is on, (Yes, in block A11), the control unit 101 performs the processing corresponding to the received remote control signal (block A12).

If the received signal is the selection control signal (Yes, in block A1), the control unit 101 executes update processing of the receiving apparatus list 201 of which the detailed operation procedure is shown in FIG. 6. FIG. 6 is an exemplary flowchart showing the detailed operation procedure of the update processing of the receiving apparatus list 201.

When receiving the selection remote control signal, the control unit 101 broadcasts a packet (signal receiving packet) to notify the fact of the reception to other apparatus via the network communication unit 103 (block B1). After this, the control unit 101 holds the reception of the signal receiving packet transmitted from other apparatus by the communication network 103 for a fixed time period (blocks B2 and B3). If the signal receiving packet is received within the fixed time period (Yes, in block B2), the control unit 101 confirms whether or not a remote control signal reception state apparatus list is present (block B8). And if it is not present (No, in block B8), the control unit 101 creates the remote control signal reception state apparatus list having no item therein (block B9). The reception state apparatus list has the same structure contents as those of the receiving apparatus list 201; however, it is a list temporally created when the signal receiving packets are transmitted from each apparatus by the selection remote control signals. If the reception state apparatus list is present (Yes, in block B8), or when the apparatus list is created in block B9, the control unit 101 checks MAC addresses from which the signal receiving packets are transmitted to add them to the apparatus list (block B10).

Blocks B2, B3, B7-B10 are repeated and after the fixed time period has elapsed in block B3, the control unit 101 compares the items of receiving apparatus list 201 with the items of the reception state apparatus list to determine whether or not the items coincide with one another completely (block B4). If the comparison results in a complete coincidence (yes, in block B4), the control unit 101 deletes the reception state apparatus list (block B5). In contrast, if the comparison does not result in the complete coincidence (No, in block B4), the control unit 101 determines whether or not this apparatus is included in the reception state apparatus list depending on the fact that whether or not the MAC address is included therein (block B11).

If the apparatus is included in the reception state apparatus list (Yes, in block B11), the control unit 11 conforms the receiving apparatus list 201 to the items of the reception state apparatus list (block B12) and sets all selection experience flags (212) of the receiving apparatus list 201 to ‘0’ (block B13). If the apparatus is not included in the reception state apparatus list (No, in block B11), the control unit 101 determines whether or not the items present in the receiving apparatus list 201 are included in the reception state apparatus list (block B14).

If the items are included in the reception state apparatus list (Yes, in block B14), because the fact means that the apparatus which received the remote control signal up to the last time does not receive it this time, the control unit 101 leaves only the items having the MAC address of the apparatus out of the reception state apparatus list (block B15) and shifts to block B12. On the contrary, the apparatus present in the receiving apparatus list 201 is not included in the reception state apparatus list (No, in block B14), the fact means that it is not related to the apparatus, so that the control unit 101 does not need to update the reception state apparatus list and deletes this apparatus list (block B16) to ends this processing.

After deleting the reception state apparatus list, the control unit 101 determines if all selection experienced flags 212 of the receiving apparatus list 201 are ‘1’ (block B6), if all of them are ‘1’, after setting them to ‘0’ (block B17), ends this processing.

After completing the update processing of the remote control signal receiving apparatus list 201, the control unit 101 retrieves the receiving apparatus list 201 in the order of younger number of the MAC addresses 211 (block A3) to find an item having the experience flag 212 of ‘0’ (block A4). When finding the item of the experience flag 212 of ‘0’ (Yes, in block A4), the control 101 sets the experience flag of the item to ‘1’ (block A5). And the control unit 101 determines whether or not the MAC address of the item is that of the apparatus (block S6), if the MAC address of the corresponding item is not that of the apparatus (No, in block A6), the control unit 101 sets the remote control receiving acceptance flag 202 to off (block A7) and sets the LED 102 to white (block A8) to terminates this processing. If the MAC address of the corresponding item is that of the apparatus (Yes, in block A6), the control unit 101 sets the acceptance flag to on (block A9) and sets the LED 102 to black (block A10) to ends the processing.

When each digital recorder 11 follows the operation procedure mentioned above, in the room A in FIG. 1, the user can switch the apparatus to be controlled in the order of 11a, 11b and 11c at every depressing the switching button 14a of the remote controller 13a. Even the same apparatus, the apparatus lid installed in the room B not being selected, the remote controller 13a can individually control the apparatuses 11a-11d depending on each room A and B.

That is to say, according to the present invention, the electronic apparatus, electronic apparatus system and remote control method capable of easily switching the one set of the electronic apparatus that is the remote operation object among the plurality of electronic apparatuses receiving the identical remote control signals can be provided.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus which is installed in an environment in which the apparatus receives a remote control signal from the same remote controller in common with other electronic apparatuses, comprising:
a receiving unit configured to receive the remote control signal;
a determination unit configured to determine one electronic apparatus to receive the remote control signal among at least one or more electronic apparatuses including the electronic apparatus able to receive the remote control signal; and
a setting unit configured to operate to accept the remote control signal received by the receiving unit when a determination result resulting from the determination unit shows the electronic apparatus as the one to receive the remote control, and to operate to disregard the remote control signal received by the receiving unit when the result shows electronic apparatuses other than the electronic apparatus.

2. The electronic apparatus according to claim 1, further comprising a display unit configured to display whether or not the electronic apparatus is set by the setting unit to receive the remote control signal.

3. The electronic apparatus according to claim 1, further comprising a communication unit configured to execute a transmission of data to a network and to execute an acquisition of data from the network, wherein the determination unit includes:
a data transmission unit configured to transmit predetermined data indicating a reception of a predetermined remote control signal to the network by the communication unit when the predetermined remote control signal is received by the receiving unit;
a data acquiring unit configured to acquire, by the communication unit, the predetermined data transmitted to the network from other electronic apparatuses;
a list creating unit configured to create a list composed of other electronic apparatuses that are transmission sources of the predetermined data acquired by the data acquiring unit and of the electronic apparatus; and
a selecting unit configured to select one electronic apparatus in accordance with a predetermined rule among electronic apparatuses on the list created by the list creating unit.

4. The electronic apparatus according to claim 3, wherein the list creating unit creates the list including identification information uniquely identifying each electronic apparatus and history information indicating a selection history of each electronic apparatus.

5. The electronic apparatus according to claim 3, wherein the selecting unit selects an electronic apparatus positioned at the top when all electronic apparatuses on a new list created by the list creating unit are ordered in accordance with the predetermined rule if structures of the new list and an existing list are different from each other, and cyclically selects electric apparatuses on the existing list and positioned next to the electronic apparatus which has been in a selected state if the structures of the new and existing lists are the same with each other.

6. The electronic apparatus according to claim 3, wherein the list creating unit creates a list composed of only the electronic apparatus when the predetermined data of which the transmission sources are other electronic apparatuses on the existing list is acquired by the data acquiring unit and also the predetermined remote control signal is not received by the receiving unit.

7. The electronic apparatus according to claim 3, wherein the list creating unit disregards the fact that the predetermined data is acquired when the predetermined data of which the transmission sources are other electronic apparatus not present on the existing list is acquired by the data acquiring unit and also the predetermined remote control signal is not received from the receiving unit.

8. An electronic apparatus system comprising a remote controller and a plurality of electronic apparatuses which each receive a remote control signal from the remote controller, wherein
the remote controller includes a section signal transmitting unit configured to transmit a selection signal to select one electronic apparatus to receive the remote control signal among the plurality of electronic apparatuses, and
each of the electronic apparatuses includes:
a receiving unit configured to receive the remote control signal including the selection signal;
a determination unit configured to determine one electronic apparatus to receive the remote control signal when the selection signal is received by the receiving unit; and
a setting unit configured to operate to accept the remote control signal received by the receiving unit when a determination result resulting from the determination unit shows the electronic apparatus as the one to receive the remote control signal, and to operate to disregard the remote control signal received by the receiving unit when the result shows other electronic apparatuses than the electronic apparatus.

9. The electronic apparatus system according to claim 8, wherein the remote controller further includes an operation button to receive a transmission instruction of the selection signal.

10. The electronic apparatus system according to claim 8, wherein each of the electronic apparatuses further includes a display unit configured to display whether or not the electronic apparatus is set by the setting unit to receive the remote control signal.

11. The electronic apparatus system according to claim 8, further comprising a network which is mutually connected the plurality of electronic apparatuses, wherein each of the electronic apparatuses further includes a communication unit configured to execute transmission of data to the network and to execute acquisition of data from the network, and
the determination unit includes:
a data transmission unit configured to transmitting predetermined data indicating a reception of a predetermined remote control signal to the network by the communication unit when the predetermined remote control signal is received by the receiving unit;
a data acquiring unit configured to acquire, by the communication unit, the predetermined data transmitted to the network from other electronic apparatuses;
a list creating unit configured to create a list composed of other electronic apparatuses that are transmission sources of the predetermined data acquired by the data acquiring unit and of the electronic apparatus; and
a selecting unit configured to select one electronic apparatus in accordance with a predetermined rule among electronic apparatuses on the list created by the list creating unit.

12. A remote control method for an electronic apparatus which is installed in an environment in which the apparatus receives a remote control signal from the same remote controller in common with other electronic apparatuses, comprising:
determining one electronic apparatus to receive the remote control signal among at least one or more electronic apparatuses possible to receive a predetermined remote control signal when the remote control signal is received; and
setting an operation to accept the remote control signal when a determination result resulting from the determining shows the electronic apparatus as the one to receive the remote control signal, and to disregard the remote control signal when the determination result shows electronic apparatuses other than the electronic apparatus.
